(19) United States
(12) Patent Application Publication
(10) Pub. No.: US 2015/0074224 A1
(43) Pub. Date: Mar. 12, 2015

(54) METHOD AND APPARATUS FOR AUTOMATIC RELOAD OF DOCUMENTS

(71) Applicant: OPERA SOFTWARE ASA, Oslo (NO)

(72) Inventors: Huib KLEINHOUT, Hagan (NO); Daniel LAZARENKO, Oslo (NO)

(73) Assignee: OPERA SOFTWARE ASA, Oslo (NO)

(21) Appl. No.: 14/481,555

(22) Filed: Sep. 9, 2014

Related U.S. Application Data
(60) Provisional application No. 61/876,189, filed on Sep. 10, 2013.

(51) Int. Cl. H04L 29/08

(52) U.S. Cl. CPC H04L 67/02; H04L 67/22
USPC 709/217

(57) ABSTRACT

The invention provides a computer-implemented method of reloading content received by a user agent in which a processor in a user device is used to execute a process comprising: receiving user input identifying a web resource; transmitting one or more requests to receive content associated with web resource; receiving content in response to the request; monitoring network activity associated with the receipt of content; and upon detecting the fulfillment of a condition predefined as a reload criterion, re-transmitting one or more of said requests.

### CROSS-REFERENCE TO RELATED APPLICATION

The present application claims domestic priority under 35 U.S.C. 119(e) to U.S. Provisional Application No. 61/876,189 filed on Sep. 10, 2013, the entire contents of which are herein incorporated by reference in their entirety.

### FIELD OF THE INVENTION

The invention relates generally to electronic devices for loading and displaying web resources and, particularly, to configuring such devices to reload resources automatically.

### BACKGROUND OF THE INVENTION

Computer users can use a variety of applications, such as web browsers and other types of user agents, to access and display web resources and other types of content. Resources available on the World Wide Web (also referred to simply as “the Web”) are typically stored in documents called web pages. Such web pages are identified by a Uniform Resource Identifier (URI), usually a Uniform Resource Locator (URL), which identifies the web page uniquely and provides the information necessary for locating and accessing the web page.

A web browser is a computer program that, when executed on a client computer, enables the client computer to read and display web pages. A web browser includes a user interface component for addressing a particular server on a network, and designating a particular document (e.g., a Web page) to be obtained from the addressed server. Using the Hypertext Transfer Protocol (HTTP), a Web browser may fetch the designated documents from the server. Also, a Web browser includes a component for displaying the content of Web pages.

Web pages may be stored on a component connected to the network (e.g., the Web), which is called a web server. Generally, a web server receives and responds to HTTP requests from a user agent or web browser. The first web pages provided static content and were rarely, if ever, updated. With the development of the web, dynamic and interactive content has become common, and a web page may become obsolete while it is being displayed by a web browser. In order to handle this situation, so-called “push” methods have been developed. The term “push” means that the web server transmits updated content to the web browser without receiving a new request from the web browser. This, however, is not a solution that is applicable to all types of content. Also, use of a push method is sometimes undesirable when the user wants to control the use of bandwidth, for example, when using a mobile device such as a smart phone. Further, implementation of the push approach can be burdensome for site developers, and often requires complex changes for websites which were built without having such an approach in mind.

Other problems that may occur when accessing web resources include interruption during data transfer, and other communication disturbances that result in incomplete or stalled loading of a web page.

Traditional web browsers are provided with reload buttons which users can click in order to initiate a new request for the web page, and thus obtain an updated version of the content or attempt to reload an incomplete or stalled web page. However, users may not be aware of the existence of updated content, and it may also be difficult to determine whether a page actually is “broken.”

Thus, it would be advantageous to employ some mechanism to automatically detect the need for reloading a page without user involvement.

### SUMMARY OF THE INVENTION

The invention provides a computer-implemented method of reloading content received by a user agent in which a processor in a user device executes a process comprising: receiving user input identifying a web resource; transmitting one or more requests to receive content associated with web resource; receiving content in response to the request; monitoring network activity associated with the receipt of content; and upon detecting the fulfillment of a condition predefined as a reload criterion, re-transmitting one or more of the requests.

While another embodiment provides for particular implementation, such as a computer-implemented method in which a processor executes a process comprising: receiving a request from a user of a user agent to access data from a web page or some other web resource; retrieving content related to the request; detecting discarded information in the content; determining if predefined criteria for reload is fulfilled; if the predetermined criteria is fulfilled, requesting a reload of the content related to the discarded information; and updating the discarded information in the content with the reloaded content.

Yet another embodiment provides a computer-implemented method in which a processor executes a process comprising: receiving a request from a user of a user agent to access data from a web page or some other web resource; retrieving content related to the request; monitoring network activities related to retrieving the content; requesting a reload of content if predefined criteria regarding monitored network activities are fulfilled; receiving the reloaded content; and providing the user of the user agent with the reloaded content.

Also, the invention provides a computer implemented method substantially consistent with the principles of the attached specification and drawings.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein

FIG. 1 is a diagram illustrating a computing device that can be used for implementing exemplary embodiments of the present invention;

FIG. 2 is diagram illustrating a user agent that may be used in conjunction with exemplary embodiments of the present invention;

FIG. 3 shows a flowchart illustrating an embodiment of the present invention regarding an implementation of a process for automatically reloading new content for computer documents;

FIG. 4 shows a flowchart illustrating an embodiment of the present invention regarding a process for optimizing the automatic reloading of broken pages;

The drawings will be described in detail in the course of the detailed description of the invention.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

The present invention is directed toward a computer-implemented method and device for automatically reloading a web page or some other web resource when it is determined that such a reload is desirable according to predefined criteria.

For instance, if a newer version of the currently-loaded content is detected as being available from the web server from which the content was originally accessed, a reload may be automatically initiated. Similarly, if a currently-loaded web page is detected to be broken, a reload may be initiated. However, there may be reasons why a reload is undesirable even if the requirements are fulfilled. Such reasons may include ongoing user interaction with the content that is currently loaded, as will be more fully described hereinbelow.

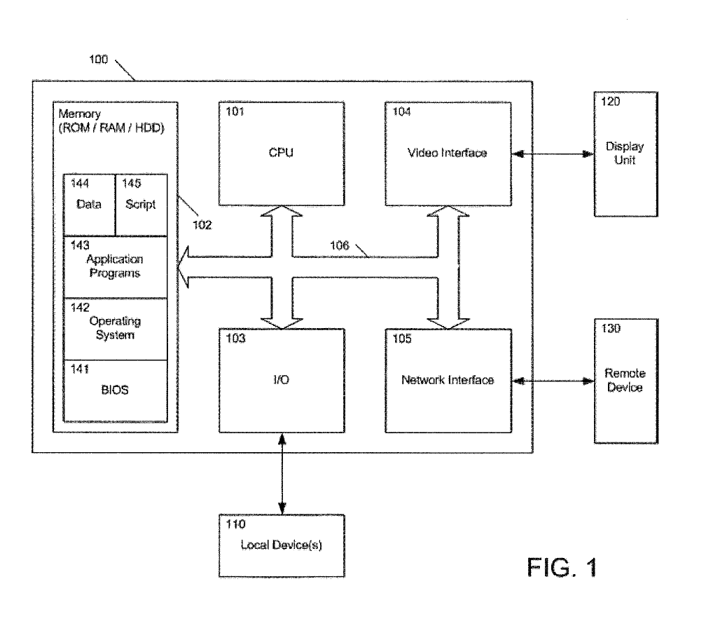

FIG. 1 illustrates a generalized computing device 100 that can be used as an environment for implementing various aspects of the present invention. According to exemplary embodiments, it is contemplated that the computer device 100 may be implemented as a mobile or handheld device, e.g., a personal digital assistant (PDA), mobile telephone, e-book device, etc. However, the principles of the present invention may be applied to other types of computer devices 100, such as desktop computer, laptop computers, and any other type of computer device 100 as will be contemplated by those of ordinary skill in the art.

In FIG. 1, a computing device 100 has various functional components including a central processor unit (CPU) 101, memory 102, communication port(s) 103, a video interface 104, and a network interface 105. These components may be in communication with each other by way of a system bus 106.

The memory 102, which may include ROM, RAM, flash memory, hard drives, or any other combination of fixed and removable memory, stores the various software components of the system. The software components in the memory 102 may include a basic input/output system (BIOS) 141, an operating system 142, various computer programs 143 including applications and device drivers, various types of data 144, and other executable files or instructions such as macros and scripts 145.

The communication ports 103 may be connected to one or more local devices 110 such as user input devices, a printer, a media player, external memory devices, and special purpose devices such as e.g. a global positioning system receiver (GPS). Communication ports 103, which may also be referred to as input/output ports (I/O), may be any combination of such ports as USB, PS/2, RS-232, infra red (IR), Bluetooth, printer ports, or any other standardized or dedicated communication interface for local devices 110.

As discussed above, the computing device 100 may include one or more user input devices among the local devices 110 of FIG. 1. Among the input device(s) there may be a pointer device, i.e., an input device which allows the user to control the position of a pointer or cursor on the screen. Such pointer devices also allow the user to click on, or perform a similar action for activating a particular function (e.g., select a displayed element) when the pointer/cursor is at a desired screen position. Examples of such pointer devices include an electronic mouse, a trackball device, and a touchpad.

The video interface device 104 is connected to a display unit 120. According to exemplary embodiments, the display unit 120 may include a touch-sensitive screen allowing the display unit 120 to double as a touch-sensitive input device. The touch-sensitive input device aspects of the display unit 120 may be considered as one of the local devices 110 communicating over a communication port 103. Further, for exemplary embodiments in which the computing device 100 is implemented as a PDA, mobile telephone, or other small portable devices, the display will generally be an integrated display such as an LCD display. However, it will be readily apparent that the principles of the present invention may be applied to situations where the display unit 220 is not integrated with the other elements of the computing device 100, e.g., where the display unit 120 is a standalone monitor.

The network interface device 105 provides the computing device 100 with the ability to connect to a network in order to communicate with a remote device 130. The communication network, which in FIG. 1 is only illustrated as the line connecting the network interface 105 with the remote device 130, may be, e.g., a local area network or the Internet. The remote device 130 may in principle be any computing device with similar communications capabilities as the device 100, but may typically be a server or some other unit providing a networked service.

It will be understood that the computing device 100 illustrated in FIG. 1 is not limited to any particular configuration or embodiment regarding its size, resources, or physical implementation of components. For example, more than one of the functional components illustrated in FIG. 1 may be combined into a single integrated unit of the device 100. Also, a single functional component of FIG. 1 may be distributed over several physical units. Other units or capabilities may of course also be present. Furthermore, the device 100 may, e.g., be a general purpose computer such as a PC, or a personal digital assistant (PDA), or even a cellphone or a smartphone.

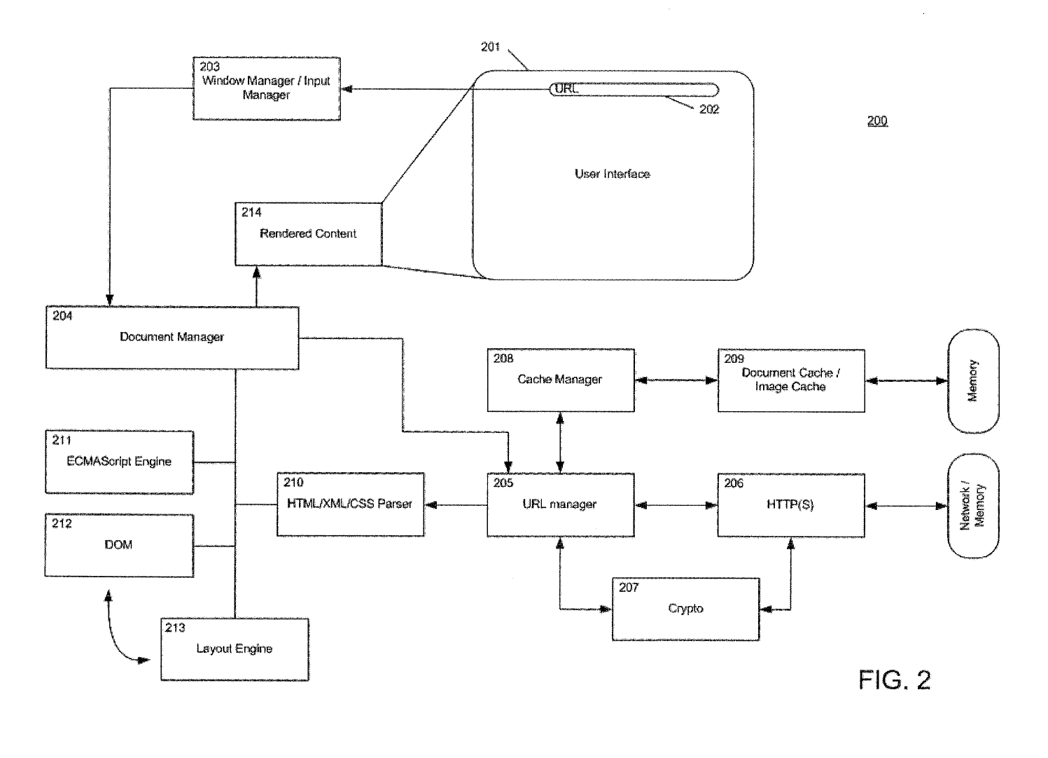

In an exemplary embodiment, various aspects of the present invention may be incorporated into, or used in connection with, the components and/or functionality making up a user agent or browser installed as an application on a computing device 100. FIG. 2 shows an example of a number of modules that may be present in such a user agent or browser. The modules will typically be software modules, or otherwise implemented by a programmer in software, and may be executed by the CPU 101. However, it is also possible for any of the modules of FIG. 2 to be implemented as hardware, a combination of hardware and software, or “firmware,” as will be contemplated by those skilled in the art.

The user agent or browser 200 presents the user with a user interface 201 that may be displayed on the display unit 120 shown in FIG. 2. The user interface 201 may include an address field 202 where the user may input or select the URL of a document or a service he or she wants the user agent 200 to retrieve. For example, the user may use a keyboard or other type of input device to type in the URL in the address field 202. The address field 202 may also be a link that is displayed and may be activated by the user by touch according to principles of the present invention (alternatively, such a link may also be activated using a pointing device such as a mouse). Alternatively the URL may be specified in the code of a document or script already loaded by the user agent 200.

In any case, the URL may be received by a window and input manager 203 that represents the input part of the user interface 201 associated with, or part of, the user agent 200. The URL may then be forwarded to a document manager 204, which manages the data received as part of the document identified by the URL.

The document manager 204 forwards the URL to a URL manager 205, which instructs a communication module 206 to request access to the identified resource. The communication module 206 may be capable of accessing and retrieving data from a remote device 130 such as a server over a network using the hypertext transfer protocol (HTTP), or some other protocol such as HTTPS or FTP. The communication module 206 may also be capable of accessing data that is stored in local memory 102.

If communication outside the device 100 is required to be encrypted, e.g., as specified by the protocol used to access the URL, encryption/decryption module 207 handles communication between the URL manager 205 and the communication module 206.

The data received by the communication module 206 in response to a request is forwarded to the URL manager 205. The URL manager 205 may then store a copy of the received content in local memory 102 using a cache manager 208 which administers a document and image cache 209. If the same URL is requested at a later time, the URL manager 205 may request it from the cache manager 208, which will retrieve the cached copy from the cache 209 (unless the cached copy has been deleted) and forward the cached copy to the URL manager 205. Accordingly, it may not be necessary to retrieve the same data again from a remote device 130 when the same URL is requested a second time.

The URL manager 205 forwards the data received from the communication port 206 or cache 209 to a parser 210 capable of parsing content such as HTML, XML and CSS. The parsed content may then, depending on the type and nature of the content, be processed further by an ECMAScript engine 211, a module for handling a document object model (DOM) structure 212, and/or a layout engine 213.

This processing of the retrieved content is administered by the document manager 204, which may also forward additional URL requests to the URL manager 205 as a result of the processing of the received content. These additional URL's may, e.g., specify images or other additional files that should be embedded in the document specified by the original URL.

When the data representing the content of the specified document has been processed it is forwarded from the document manager 204 in order to be rendered by a rendering engine 214 and displayed on the user interface 201.

The various modules thus described are executed by the CPU 101 of the computing device 100 as the CPU 101 receives instructions and data over the system bus(es) 106. The communications module 206 communicates with the remote device 130 using the network interface 105. The functionality of various modules in FIG. 1 may of course be integrated into fewer larger modules. Also, the functionality of a single module in FIG. 1 may be distributed or replicated over several modules.

It will further be understood that, while the user agent 200 described above may be implemented as an application program 143, some of the user agent's 200 functionality may also be implemented as part of the operating system 142 or even the BIOS 141 of the computing device 100. The content received in response to a URL request may be data 144, script 145, or a combination thereof as further described below.

The invention provides a process for automatically reloading a web page or some other web resource when such reloading is desirable according to predefined criteria. Initially, a user can send a request from a user agent to access data from a web page or some other web resource. The user agent retrieves content related to the request, and requests a reload of content if predefined criteria for reloading are fulfilled. When the predefined criteria for reload are fulfilled, an automatic reload of the content occurs, and the user is then provided with reloaded content.

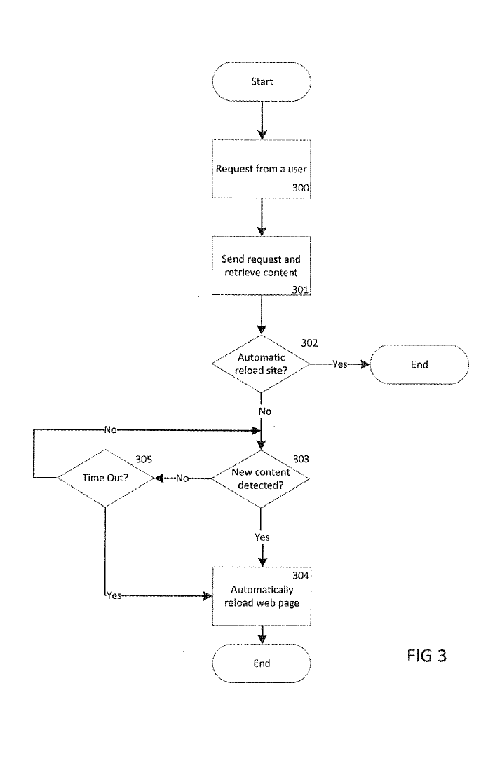

Reference is now made to the flowchart shown in FIG. 3. FIG. 3 shows an implementation of the process of automatically reloading new content for computer documents, particularly web pages which are transferred to a user agent in response to a request made by a user in step 300. When the user agent receives a request from the user, the request can be transmitted (e.g., as an HTTP request) to an appropriate location (e.g., web server) in order to retrieve content for the user in step 301. If cached information related to the request already exist on the device, this content may be (but does not have to be) initially retrieved from the cache 209 in step 301. After the content is retrieved in step 301, there may be a need for reloading one or more retrieved web pages in order to provide the user with updated content.

In step 302, a determination is made as to whether the requested web page supports the feature of automatic reloading. If step 302 decides that the requested web page supports the feature of automatic reloading, the reloading of content is handled by this feature of the web page, and thus the method of FIG. 3 may terminate.

If, however, step 302 decides that the web page does not support automatic reloading, an operation for detecting new content is initiated in step 303. There are several ways in which new content can be detected. Most web pages contain some information that can be interpreted and used by the user agent to detect new content.

One of the ways for detecting new content is by detecting that a web page declares new content through the use of web syndication protocols, such as RSS, Atom Fees, Otatus and Active Steams. Another way of detecting new content is by using HTTP caching mechanisms, where specific HTTP headers give information regarding a date of change, and time intervals when a web page is required to be refreshed. With the use of periodic header requests, new content can be polled.

Yet another way of detecting new content is to implement a webpage-specific method for the detection of new content, whereupon new content can be polled. Other ways of detecting new content may also be implemented.

After automatically reloading a web page (step 304), the updated content can be updated 304 with the new content. For example if new content is received by the URL manager 205, the URL manager 205 forwards data from the cache 209 and new content data received from the communication port 206, to the parser 210 capable of parsing cached and new content.

If no information regarding new content of the requested web page is detected, and a threshold time interval has expired since the last loading/reloading of the webpage (as decided by step 304), the web page can be automatically reloaded in step 305. In other words, if the content in the current web page has “expired,” then step 305 may be used to automatically reload the web page.

To check whether or not content in the currently-loaded web page has “expired” in step 305 (i.e., exceeds the threshold timeout interval), the URL manager 205 may obtain information from the cache manager 208 as to the last time the cache 209 was updated in regard to content relating to the web page. Based on this information, the URL manager 205 can calculate the duration since the last loading or reloading of the web page, and determine whether this duration exceeds the threshold time interval. If the answer is “Yes,” the web page content can be automatically reloaded in step 305, e.g., by having the URL manager 205 send a request via the communication module 206. The threshold timeout interval can be set by the user, can be predefined in the web pages or be predefined in a user agent.

Although FIG. 3 illustrates that the process terminates upon an automatic reload of the web page in step 304, this need not be the case. According to an alternative embodiment, after the web page is automatically reloaded in step 304, processing could loop back to step 303. This would allow the web page to be continually updated whenever new content is detected (“Yes” decision in step 303) or the current content has expired (“Yes” decision in step 305).

There are web pages that support automatic reloading. If support for automatic reloading is provided by the web site, there may not be need for detecting new content according to step 303. For this reason, step 302 (mentioned above) is provided to determine whether or not automatic reloading is supported by the web page. Automatic reloading can be detected by the presents of HTML “meta refresh”-tag, or by detecting reloads issued by ECMAScript code, such as “location.reload( )” and “location.assign( ).” Other programming languages can also provide suitable functionality. Automatic reloading can also be detected as a web page is reloaded within the threshold time out interval.

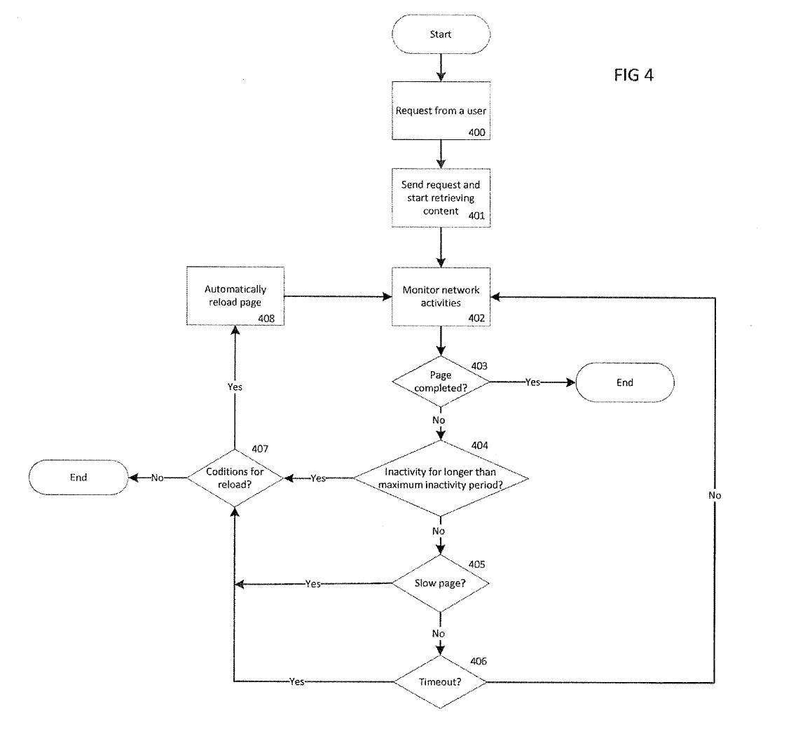

Reference is now made to the flowchart shown in FIG. 4. The invention provides a process for optimizing the automatic reloading of broken pages, particularly in regard to web pages served up to a user agent in response to a request from a user.

In FIG. 4, the user request is received by the user agent in step 400. When receiving a request from the user, the user agent forwards the request to the appropriate location (e.g., web server) in step 401 in order to start retrieving content of the requested web page for the user.

Broken pages are often due to network failure, such as the failure to load a complete web page when a response from a server is not received. Several ways of detecting broken pages are contemplated. Thus, while the requested web page is being retrieved, network activity can be monitored in step 402 for purposes of detecting a broken page. Such a monitoring process can constantly estimate network characteristics such as latency and speed for the network connection. Based on the monitored network characteristics, variables such as a timeout, a maximum inactive period length, a threshold latency, an average latency, and a maximum response waiting time can be estimated.

One way to detect the need for an automatic reload is to estimate the length of network inactivity during the loading process. If there has been no loading activity in regard to the requested page for a period of time exceeding the maximum inactive period length, the page can be considered as a broken page.

Another way of detecting need for an automatic reload is by detecting “slow pages.”

If the current latency is longer than the threshold latency, the page will be considered a “slow page.” If a page is marked as a “slow page,” the page may be considered to be a broken page, and a reload may be desirable. The current latency in loading the page can be constantly estimated, and the threshold latency can be a value that is set according to the average latency in the network connection. If after a page is marked as a “slow page,” the current latency changes to become shorter than the threshold latency, the page may no longer be considered a “slow page.”

Other ways for detecting the need for an automatic reload by use of monitored network characteristics can be implemented.

Referring again to FIG. 4, when the requested web page is completely loaded within the time limits of the timeout (a “Yes decision in step 403), the page can considered as being successfully loaded, and the process terminates.

If the web page has not been completely loaded at this time (a “No” decision in step 403), it is checked in step 404 whether there has been a period of inactivity in regard to the web page loading, which exceeds the maximum inactivity period. If there has been a period of inactivity exceeding this maximum inactivity period (a “Yes” decision in step 404), the web page is considered to be broken, and processing proceeds to step 407. Otherwise, a check is made in step 405 as to whether the web page can be considered a “slow page,” i.e., whether the current latency is longer than the threshold latency. If the page is a “slow page” (a “Yes” decision in step 405), then the page may be considered to be broken, and processing proceeds to step 407.

If the page is not considered a “slow page” according to step 404 or 405, then a check is made in step 406 whether or not the timeout time limit has expired without the web page being completed. If this time limit has expired and the web page has not yet been completed (a “Yes” decision in step 406), the web page can be considered as broken and processing may proceed to step 407.

A page that is considered to be broken can have different conditions for reloading. If these conditions are met, reloading of the page can be performed automatically (in step 408), or alternatively a “reload” button can be suggested to the user.

If a broken page is detected (“Yes” decision) by any of steps 404, 405, or 406, an automatic reload is performed when step 407 determines that the conditions for automatic reloading are fulfilled.

The reason for implementing step 407 is as follows. There is a need to restrict the use of automatic reloads, as there may be several circumstances under which the automatic reload is not required or desirable. Conditions for reloading (as applied by step 407) can be set by the web page, set by the user, or preset in a user agent. Examples of possible conditions for halting or postponing the automatic reloading process include: the OS is in sleep mode, is idle, or is in standby mode; the user agent is in background; the web page is not active; and/or a user input in connection with the web page has been detected. Also, it is not desirable to do an automatic reload on web pages that are loaded with non-idempotent HTTP methods. However, if indicated by the user or by information retrieved from the web page, and network recourses are available, an automatic reload of a web page can run in the background.

There are other conditions (such as wake-up events or an active web page in the foreground) that could be used to indicate that an automatic reload is desirable. If the conditions for reloading are fulfilled (a “Yes” decision in step 407), an automatic reloading of the web page can be performed in step 408.

Further, information in regard to the reloading of web pages can be stored in a database. For instance, if the reloading process is forced to quit, information such as the time and state are stored. Thus, if the reloading process is started again, the reload process can continue according to the stored information. For example, on web pages that streams video or audio content, it would be desirable to the user that the automatic reload starts at the last known time and state of the stream or audio content.

The invention being thus described, it will be obvious that the same may be varied in many ways. Such variations are not to be regarded as departure from the spirit and scope of the invention, and all such modifications as would be obvious to one skilled in the art are intended to be included within the scope of the following claims.

1. A computer-implemented method of reloading content received by a user agent comprising:
utilizing a processor in a user device to execute a process comprising:
receiving user input identifying a web resource;
transmitting one or more requests to receive content associated with said web resource;
receiving content in response to said request;
monitoring network activity associated with the receipt of said content; and
upon detecting fulfillment of a condition predefined as a reload criterion, re-transmitting one or more of said requests.

2. The computer-implemented method of claim 1, wherein the predefined reload criterion relates to user activity.

3. The computer-implemented method of claim 2, wherein the predefined reload criterion corresponds to user input detection.

4. The computer-implemented method of claim 1, wherein the predefined reload criterion corresponds to a status in operating system where the user agent is installed.

5. The computer-implemented method of claim 1, wherein the predefined reload criterion corresponds to detection of expired information of the retrieved content.

6. The computer-implemented method of claim 1, wherein the predefined reload criterion relates to network activities.

7. The computer-implemented method of claim 1, wherein content can be retrieved based on the use of periodic header requests.

8. The computer-implemented method of claim 1, wherein content can be retrieved by polling a web feed stream.

9. A computer-implemented method comprising:
utilizing a processor in a user device to execute a process comprising:
receiving a request from a user of a user agent to access data from a web page or some other web resource;
retrieving content related to the said request;
detecting expired information in said content;
determining if predefined criteria for reload is fulfilled;
requesting a reload of said content related to said expired information; and
updating the expired information in said content with said reloaded content.

10. A computer-implemented method comprising:
utilizing a processor in a user device to execute a process comprising:
receiving a request from a user of a user agent to access data from a web page or some other web resource;
retrieving content related to the said request;
monitoring network activities related to retrieving said content;
requesting a reload of content if predefined criteria regarding said monitored network activities are fulfilled;
receiving reloaded content; and
providing the user of the user agent with said reloaded content.
